(19) United States
(12) Patent Application Publication
(10) Pub. No.: US 2026/0120123 A1
(43) Pub. Date: Apr. 30, 2026

(54) Dynamic Trust-Weighted Compliance Engine

(71) Applicant: George Bickerstaff Bickerstaff, III, Greenwich, CT (US)

(72) Inventor: George Bickerstaff Bickerstaff, III, Greenwich, CT (US)

(21) Appl. No.: 19/434,085

(22) Filed: Dec. 29, 2025

(51) Int. Cl. G06Q 30/018

(52) U.S. Cl. CPC G06Q 30/018; G06Q 2220/00

(57) ABSTRACT

A dynamic trust-weighted compliance engine enhances blockchain governance by transforming real-time regulatory data into a synchronous blockchain state-tree via a processor within a secure virtual environment on centralized cloud nodes, excluding non-compliant transactions before block proposal. The system includes a blockchain interface for voting across multiple networks (e.g., Ethereum, Hyperledger), a compliance validation module adjusting trust scores with a dynamic weight adjustment algorithm using hashed commitments and standard cryptography, and an output module transmitting adjusted scores to a decentralized voting system. The engine validates regulatory changes against a quarterly-updated compliance database and operates on a distributed ledger with a user interface for manual oversight, applicable to decentralized finance and regulatory technology platforms.

### FIELD OF THE INVENTION

This invention pertains to blockchain governance systems, specifically a dynamic trust-weighted compliance engine that enhances the computational efficiency and security of decentralized ledgers through real-time regulatory updates and trust-based voting mechanisms.

### BACKGROUND OF THE INVENTION

Decentralized blockchain governance, as disclosed in U.S. Publication No. US-2025-0391219-A1 (filed Aug. 26, 2025, published Dec. 25, 2025), relies on trust-weighted voting but lacks real-time regulatory adaptation. Similarly, predictive influence modeling in U.S. Publication No. US-2025-0392470-A1 (filed Aug. 21, 2025, published Dec. 25, 2025) does not address compliance, leaving a technical gap in preventing invalid network states. The present invention addresses this by optimizing consensus overhead and introducing a compliance engine. Non-proprietary technical milestones have been documented in a public repository (e.g., GitHub) to establish prior art and prevent leapfrogging by competitors.

### SUMMARY OF THE INVENTION

The invention provides a dynamic trust-weighted compliance engine that reduces computational overhead during consensus using trust-weights as pre-validated cryptographic shortcuts, integrates real-time regulatory updates, and ensures voting aligns with legal standards. The system operates on blockchain networks (e.g., Ethereum, Hyperledger) with predictive influence models, utilizing a distributed ledger enhanced by standard cryptographic methods, and is applicable to decentralized finance and regulatory technology platforms.

### BRIEF DESCRIPTION OF THE DRAWINGS

FIG. 1: SYSTEM VIEW

FIG. 1A: CENTRAL PROCESSING UNIT

FIG. 1B: CENTRAL PROCESSING UNIT

FIG. 1C: COMPLIANCE DATABASE

FIG. 1D: REAL-TIME DATA FEED

FIG. 1E: OUTPUT SCORE MODULE

FIG. 1F: HARDWARE WITH SECURE NODES

FIG. 2: DATA PATH

FIG. 2A: INPUT UPDATE MODULE

FIG. 2B: RULE PARSING UNIT

FIG. 2C: COMPLIANCE CHECK LAYER

FIG. 2D: FEEDBACK LOOP

FIG. 2E: ERROR REPORT TOOL

FIG. 3: TRUST FLOW

FIG. 3A: INITIAL SCORE CALCULATION

FIG. 3B: IMPACT EVALUATION MODULE

FIG. 3C: WEIGHT ADJUSTMENT ALGORITHM

FIG. 3D: STANDARD VALIDATION

FIG. 3E: UPDATED SCORE OUTPUT

FIG. 4: ENGINE LINK

FIG. 4A: INFLUENCE DATA INPUT

FIG. 4B: CONSTRAINT OVERLAY UNIT

FIG. 4C: SCORE GENERATION MODULE

FIG. 4D: FEEDBACK TO LAYER

FIG. 4E: AUDIT LOG RECORD

FIG. 5: USER SCREEN

FIG. 5A: STATUS DISPLAY PANEL

FIG. 5B: SCORE VISUALIZATION TOOL

FIG. 5C: COMPLIANCE INDICATOR

FIG. 5D: ALERT SYSTEM UNIT

FIG. 5E: MANUAL OVERRIDE CONTROL

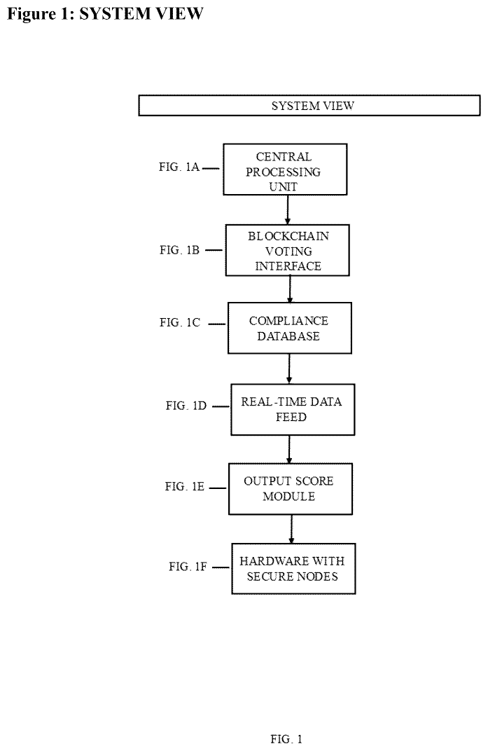

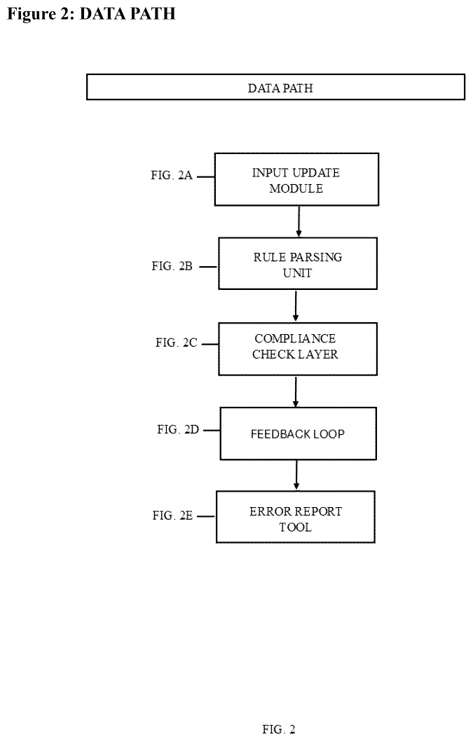

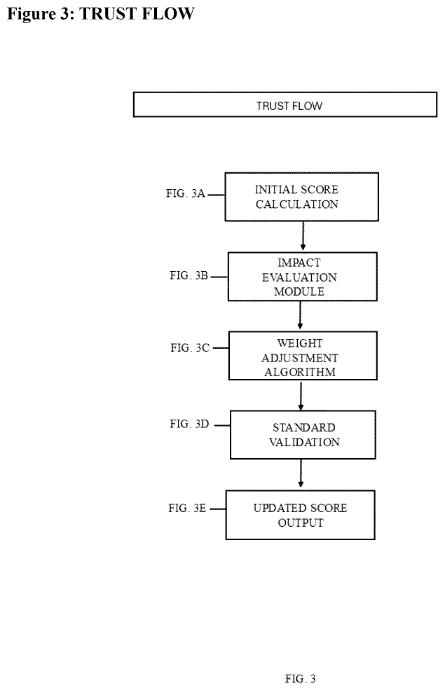

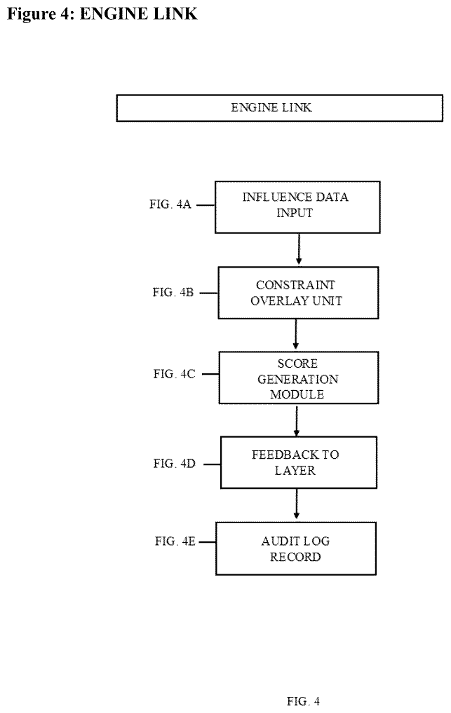

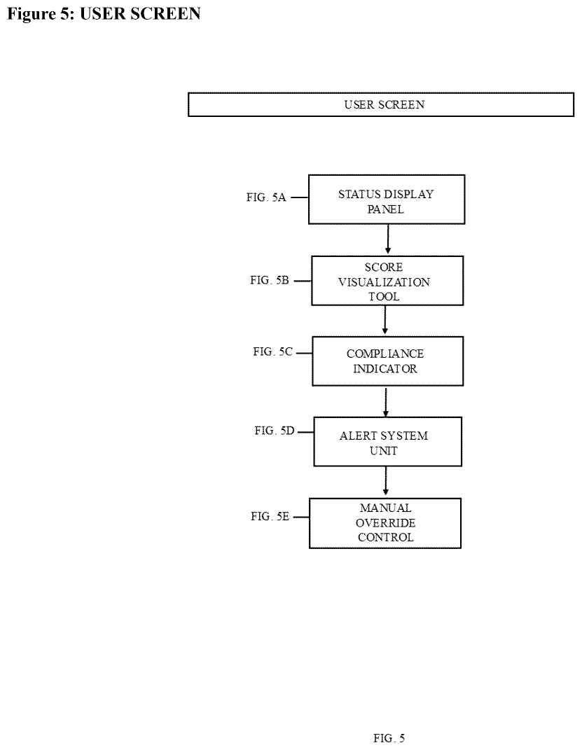

### DETAILED DESCRIPTION

The dynamic trust-weighted compliance engine comprises a processor configured to receive real-time regulatory data from a plurality of sources via a decentralized oracle network, processed within a secure virtual environment to ensure data integrity. Real-time regulatory data is ingested through a decentralized oracle network with a latency threshold of under one second, ensuring timely state-tree updates. The processor, deployed on centralized cloud nodes for optimized latency, integrates with a blockchain interface for trust-weighted voting across multiple networks (e.g., Ethereum, Hyperledger). A compliance validation module adjusts trust scores using a dynamic weight adjustment algorithm that serves as a pre-validated cryptographic shortcut, optimizing consensus overhead by reducing node-by-node validation. This algorithm maps asynchronous regulatory API feeds into a synchronous blockchain state-tree using a hash-based indexing method compatible with Ethereum smart contracts, enhanced by hashed commitments to verify compliance without revealing sensitive data, and employs standard cryptographic methods for future resilience. An output module transmits adjusted scores to a decentralized voting system. The engine validates regulatory changes against a quarterly-updated compliance database, acting as a hardware-enforced guardrail to prevent illegal network states by integrating predictive influence data from the forecasting engine of US-2025-0392470-A1 and the voting execution mechanism of US-2025-0391219-A1. The system synchronizes predictive influence data from US-2025-0392470-A1 with voting execution from US-2025-0391219-A1, ensuring compliance enforcement aligns with forecasted trends and executed votes. The system excludes non-compliant transactions before block proposal, operates on a distributed ledger, supports cross-platform synchronization with wealth management systems, and includes a user interface for manual oversight. The system supports compliance enforcement across diverse use cases, including DAO governance, RegTech platforms, and tokenized asset networks, enhancing licensing flexibility.

1. A dynamic trust-weighted compliance engine for blockchain governance, comprising: a processor configured to execute real-time ingestion of regulatory data from a plurality of sources via a decentralized oracle network within a secure virtual environment on centralized cloud nodes, transforming said data into a synchronous blockchain state-tree and excluding non-compliant transactions before block proposal; a blockchain interface for integrating trust-weighted voting across a plurality of blockchain networks; a compliance validation module configured to adjust trust scores using a dynamic weight adjustment algorithm that optimizes consensus overhead by mapping asynchronous regulatory API feeds into said state-tree through a weighted averaging function based on regulatory priority; and an output module to transmit said adjusted trust scores to a decentralized voting system.

2. A method for dynamically adjusting trust weights in a blockchain governance system, comprising the steps of: receiving real-time regulatory data from a plurality of sources via a decentralized oracle network within a secure virtual environment on centralized cloud nodes, transforming said data into a synchronous blockchain state-tree; processing said regulatory data through a compliance validation module; adjusting trust scores of stakeholders using a dynamic weight adjustment algorithm that optimizes consensus overhead by mapping asynchronous regulatory API feeds into said state-tree; and updating a decentralized voting system with said adjusted trust scores.

3. A non-transitory computer-readable medium storing instructions that, when executed by a processor within a secure virtual environment on centralized cloud nodes, cause the processor to perform a method for ensuring compliant blockchain governance, comprising: monitoring real-time regulatory updates from a plurality of sources via a decentralized oracle network, transforming said updates into a synchronous blockchain state-tree; validating said updates against a compliance database updated at regular intervals; dynamically modifying trust weights in a voting layer using a dynamic weight adjustment algorithm that optimizes consensus overhead by mapping asynchronous regulatory API feeds into said state-tree; and transmitting said modified trust weights to a blockchain network.

4. The engine of claim 1, wherein the compliance validation module employs hashed commitments to verify compliance without revealing sensitive stakeholder data.

5. The engine of claim 1, wherein the dynamic weight adjustment algorithm incorporates standard cryptographic methods for future resilience.

6. The engine of claim 1, wherein the processor is further configured to receive predictive influence data from an influence forecasting engine as disclosed in U.S. Publication No. US-2025-0392470-A1.

7. The engine of claim 6, wherein the compliance validation module is configured to adjust trust scores based on said predictive influence data.

8. The method of claim 2, further comprising the step of logging compliance adjustments in a blockchain audit trail accessible to authorized regulatory bodies.

9. The medium of claim 3, wherein the instructions further cause the processor to generate alerts for non-compliant trust weights.

10. The engine of claim 1, wherein the plurality of blockchain networks includes Ethereum and Hyperledger.

11. The method of claim 2, further comprising the step of validating adjusted trust scores against historical compliance data updated quarterly.

12. The medium of claim 3, wherein the instructions cause the processor to integrate with a cross-platform synchronization engine aligning voting data across wealth management systems.

13. The engine of claim 1, further comprising an atomic swap protocol that halts cross-chain asset transfers if the trust-weighted compliance score falls below a dynamically calculated regulatory threshold.
